(19) United States
(12) Patent Application Publication
(10) Pub. No.: US 2005/0142371 A1
(43) Pub. Date: Jun. 30, 2005

(54) Phosphorescent sheets or films having protective topcoat and methods of making the same

(76) Inventors: Stuart D. Swain, Winona, MN (US); Wayne Kronebusch, Rollingstone, MN (US); Nathan Bergler, Winona, MN (US); Bill Minogue, Phoenixville, PA (US)

Correspondence Address: MCDERMOTT, WILL & EMERY LLP, 227 WEST MONROE STREET, CHICAGO, IL, 60606-5096, US

(21) Appl. No.: 10/987,224

(22) Filed: Nov. 12, 2004

Related U.S. Application Data
(63) Continuation-in-part of application No. 10/214,996, filed on Aug. 8, 2002.
(63) Continuation-in-part of application No. 10/282,896, filed on Oct. 29, 2002.
(60) Provisional application No. 60/385,151, filed on May 31, 2002.
(60) Provisional application No. 60/385,151, filed on May 31, 2002.

(51) Int. Cl. B32B 5/16; B32B 27/08

(52) U.S. Cl. 428/516; 428/323; 428/520

(57) ABSTRACT

Glow-in-the-dark rigid and flexible polymeric thermoplastic sheets or films, and methods of making the same are provided. Specifically, the sheets or films may include a reflective backing that provides directional luminescence. In addition, the sheets or films may include a flame-retarded resin and/or flame retardant additive. Moreover, the sheets or films may include a protective topcoat to protect the phosphorescent sheets or films from abrasive materials, moisture, oils, and/or acidic or alkaline materials. The sheets or films of the present invention may further have adhesive materials disposed on a surface of the phosphorescent sheets or films for adhering the sheets or films to surfaces. The sheets or films of may further be printable without requiring pretreatment of the sheets or films. In addition, the sheets or films may be laser markable.

The present invention is a Continuation-In-Part of U.S. patent application Ser. No. 10/214,996, filed on Aug. 8, 2002 and U.S. patent application Ser. No. 10/282,896 filed on Oct. 29, 2002, each of which claims priority to U.S. Provisional Patent Application No. 60/385,151, filed on May 31, 2002.

### TECHNICAL FIELD

The present invention relates to phosphorescent thermoplastic rigid or flexible sheets or films, and methods of making the same. More specifically, the present invention relates to thermoplastic sheets or films that have a phosphorescent material incorporated into a layer or layers of the thermoplastic sheets or films. In addition, the thermoplastic sheets or films may include a reflective backing material that provides directional luminescence. Moreover, flame-retardant material or flame retardant additives may be incorporated into the thermoplastic sheets or films. Still further, one or more protective topcoat layers may be provided on the thermoplastic sheets or films. The phosphorescent sheets and films are useful for signage or other visual indicators and are useful in non-illuminated areas or areas having low levels of illumination.

### BACKGROUND

It is generally known to provide signage that glows to transmit to a user or reader certain information. Typically, luminescent signage is useful in locations where an external light source is not provided, where an external light source provides relatively low levels of illumination, or where an external light source may be extinguished making it difficult to view non-luminescent signage. For example, power failures may cause external light sources to be extinguished, thereby creating a need for a luminescent signage indicating instructions or providing direction to individuals. In addition, in locations that do not normally utilize external light sources, such as theaters or the like, luminescent signage is useful to communicate instructions or direction to individuals. For example, in theaters, it is useful to provide signage over exits that indicates the presence and location of the exits. Of course, the signage must be readable in the darkness of the theater. Still further, illuminated signage is useful on highways, roadways or other transportation means to communicate to drivers information in non-illuminated areas, such as at night or in tunnels.

Typically, luminescent signage is manufactured using bulbs that glow due to the excitation of a filament or a gas by an electric current. The bulbs are typically placed inside a box where words or symbols may be disposed on a surface of the box. The words or symbols of the signage may be blocked, in one aspect, or transparent or translucent in another aspect. If the letters or symbols are blocked, then typically the remaining surface where the letters are disposed is transparent or translucent, thereby creating dark letters on a lighted background, when light shines through the surface. Alternatively, if the letters or symbols are transparent or translucent, then the remaining surface that the letters or symbols are disposed on may block the light from shining therethrough, thereby creating lighted letters on a dark background. However, this signage is relatively large, bulky, and heavy because of the various electrical components that must be contained within the signage. For example, signage of this nature must include space for the bulbs, bulb receptacles, and wires. In addition, to protect the electrical components of the signage and to satisfy safety requirements, heavy materials must be used to encase the signage, such as metal or thick plastic.

In addition, illuminated signage may be manufactured having reflective symbols that are illuminated by an external light source, such as bulbs, that may be placed a distance from the signage and directed at the signage to illuminate the symbols on the signage. For example, many billboards on roadsides or highways have a strip of lights with a plurality of bulbs therein directed at the billboard so that motorists may view the billboard at night.

It is further known to provide a series of bulbs on floors, stairs or other walkable areas to allow individuals to see where they are walking when there is little or no external light source. For example, passenger airplanes, trains, subways, buses and the like typically have a series of bulbs placed in two parallel lines along aisles to direct individuals where to walk at times when there is little to no external light, or during emergencies when light sources may be extinguished, such as during an emergency. The bulbs are typically mounted directly into the floor and the bulbs are encased in a transparent or translucent plastic to allow the light to shine therethrough.

Since bulbs must typically have space therein to house the filament or gas, bulbs typically are roundish with a volume therein for the filament or gas. This limits the usefulness of the bulbs in that the bulbs need space to be housed. In addition, bulbs require electrical current. The bulbs, therefore, must be tied to electrical wires so that an electric current may be supplied to the bulbs. Each bulb must be tied to an individual wire. Of course, in situations where external light sources are extinguished due to power failures, luminescent signage requiring electricity would be useless and bulkier battery packs are necessary.

Further, it is generally known that certain materials have the ability to phosphoresce. Phosphorescence generally refers to the ability of a material to emit visible light after being excited by radiation and typically relates to the persistent afterglow of a material after the radiation has been removed from the material. As opposed to fluorescence, which is the excitation of a material at the instant it is excited by radiation, phosphorescence may persist for hours or even days after the excitation of the material. According to a theory first advanced by physicist Philip Lenard, energy is absorbed by a phosphorescent substance, typically a crystalline material, causing some of the electrons of the substance to be displaced and trapped in potential troughs. These electrons are eventually freed by temperature-related energy fluctuations within the substance. As the electrons fall back to their original states, they release their excess energy in the form of light.

Many phosphorescent materials are known, including sulfides, metal aluminate oxides, silicates and various rare earth compounds (particularly rare earth oxides). The most commonly used of these phosphorescent materials is zinc sulfide (ZnS), which is activated by the substitution of zinc and various elemental activators. With zinc sulfide, an activator, coactivator or compensator is usually necessary, such as copper, aluminum, silver, gold, manganese, gallium, indium, scandium, lead, cerium, terbium, europium, gadolinium, samarium, praseodymium or other rare earth elements and halogens.

Another important class of long-life phosphorescent materials is the metal aluminates, particularly the alkaline earth aluminate oxides, such as strontium aluminum oxide, calcium aluminum oxide, barium aluminum oxide, and mixtures thereof. These materials may further be activated by other metals and rare earths. For example, U.S. Pat. No. 4,795,588 to Pet et al. illustrates the preparation of luminescent EU²⁺ activated strontium aluminate.

The phosphorescent properties of certain materials make them useful in applications where a lingering luminescence is desired after an external light source is extinguished. For example, phosphorescent materials are used in gel-coated articles and molded, cast and fiberglass reinforced thermosetting articles, as disclosed in U.S. Pat. No. 6,207,077 to Burnell-Jones. In addition, phosphorescent material, or electroluminescent materials, are used in many devices including fluorescent lamps, plasma-panel display gas-discharge cells, electron-beam display devices, and other emissive displays, as described in U.S. Pat. No. 6,203,726 to Danielson et al.

However, prior art phosphorescent materials are typically incorporated into rigid materials that are difficult to manipulate into flat sheets or films that are useful as signage or strips to be utilized as markers on floors and the like.

As noted, it is known to provide phosphorescent material into articles and materials in which a glow is desired. However, glow material that is incorporated into extruded thermoplastic material has limited usefulness because the phosphorescent particles typically scrape the metal surfaces of extrusion machinery thereby infusing the phosphorescent material with impurities that interfere with the crystalline structure of the phosphorescent particles. This typically severely reduces the luminescence of the material.

Still further, articles having phosphorescent materials incorporated therein provide luminescence in any direction. Typically, luminescence of signage is desired in only one specific direction. For example, on signage and strips running along a floor, luminescence is only desired in the direction from which the signage or strip is to be viewed. Any luminescence in a direction that is not viewable is wasted.

In addition, since phosphorescent materials must be transparent or translucent so that light may easily be transmitted through the material (in order to maximize the use of the phosphorescent materials), typical phosphorescent materials are difficult to mark, such as with a laser, or other source of radiation to provide patterns thereon, or other markings. The transparency or translucency of the phosphorescent material typically transmits the energy of a laser beam, or other radiation source, making it difficult for the laser to char or otherwise mark the material.

Another limitation in prior art articles having phosphorescent particles incorporated therein is that the articles are typically not flame-retarded, in that when exposed to a flame or other fire source, an article will typically burn and/or emit noxious smoke and/or fumes. For example, a particular type of thermoplastic material, polyvinylidene chloride copolymer, may emit noxious chlorinated fumes, such as hydrochloric acid, or other gases, that are extremely harmful if inhaled. In applications where signage or other uses are necessary in an enclosed space, such as, for example, on airplanes, trains, subways, buses or theaters, flame-retardancy requirements must typically be met before the materials are used.

Moreover, typical phosphorescent sheets or films are not protected from contact with abrasive materials, moisture, oils, and/or acidic or alkaline materials. Moreover, phosphorescent sheets or films may not be printable with water or solvent-based inks using typical and well-known printing methods, such as flexography, offset lithography, screen printing, UV curable ink printing and inkjet printing. Phosphorescent sheets or films may require pre-treatment of the surface of the sheets or films for printing. In addition, phosphorescent sheets or films may not accept a laser-mark. In addition, phosphorescent sheets or films may be susceptible to out-gassing, which may cause distortions of the sheets or films or produce disagreeable odors.

Further, prior art sheets or films may not be adherable to surfaces, such as drywall, plaster, cinder block, concrete, laminate surfaces, painted surfaces, wall paper, wood, plastic moldings, and metal, such as, for example, aluminum and steel.

A need, therefore, exists for rigid or flexible thermoplastic sheets or films that have phosphorescent characteristics and methods of making the same for compositions that are useful for signage or strips, among other articles. More specifically, a need exists for rigid or flexible sheets or films that provide directional luminescence, and further contains flame-retarded resin and/or flame retardant additive, and/or is laser-markable. Moreover, a need exists for phosphorescent rigid or flexible sheets or films having protective coatings to protect the sheets or films from environmental factors, such as abrasive materials, moisture, oils, and/or acidic or alkaline materials. Moreover, a need exists for rigid or flexible sheets or films that are easily printable, especially without pretreatment of the sheets or films. Still further, a need exists for rigid or flexible phosphorescent polymeric sheets or films that minimize or eliminate out-gassing to eliminate distortions of the sheets or films and/or odors associated therewith. In addition, a need exists for a method of manufacturing rigid or flexible thermoplastic sheets or films that are not subject to impurities from the extrusion machinery thereby reducing the luminescent qualities of the material.

### SUMMARY

The present invention relates to thermoplastic phosphorescent rigid or flexible sheets and/or films. In addition, the present invention relates to methods of making the same. More specifically, the present invention relates to multilayer rigid or flexible sheets or films having phosphorescent particles incorporated into layers of the sheets or films. In addition, the sheets or films include a layer of reflective material provided on a backside of the sheet or film that reflects luminescence of the phosphorescent particles. This allows for directional glow and an increase in brightness and glow duration. In addition, the sheets or films may include flame retarded resin and/or flame retardant additives incorporated therein. Still further, the present invention relates to a method of making the rigid or flexible thermoplastic phosphorescent sheets or films that minimizes impurities from interfering with the luminescent characteristics.

It is, therefore, an advantage of the present invention to provide sheets or films having phosphorescent particles contained therein that may be utilized in signage that communicates information to an individual when external lights have been extinguished. The sheets or films may be easily manufactured using extrusion technology. Further, the sheets or films may further include multiple layers, wherein a first layer includes the phosphorescent material, and the second layer includes a reflective material to direct the luminescence of the sheet or film in a particular direction. The sheets or films of the present invention may further include a top coat layer consisting of a light reflective material that reflects light or radiation that is shone upon the sheets or films. The sheets or films, depending on the loading of the phosphorescent pigment, thicknesses of the sheets or films, and the characteristics of a reflective layer, can visibly glow for many hours or even days in total darkness.

Further, it is an advantage of the present invention to provide sheets or films that are lightweight and can be easily mounted in areas that would be viewable by individuals desiring to view the sheets or films. For example, the sheets or films may be easily mountable over doors to indicate exits from a room when external lights have been extinguished. In addition, the sheets or films of the present invention may be utilized as evacuation routing signage or other safety related signage in hallways and/or staircases, or any other location.

In addition, it is an advantage of the present invention to provide sheets or films having phosphorescent particles contained therein to provide luminescence without the need for bulbs or electricity. The sheets or films, therefore, can be flat and thin and take up little space. In addition, the sheets or films may be placed in areas where electricity is difficult to reach, yet still provide enough luminescence to communicate information to an individual that may view the sheets or films. Further, the sheets or films do not require large, bulky and heavy housings or casings.

Still further, it is an advantage of the present invention to provide sheets or films having luminescent properties that are easily slit or cut so that narrow strips of the luminescent sheets or films may be produced. These narrow strips may be utilized on floors or otherwise to provide direction to individuals. In addition, the strips may be cut into any pattern or symbol, such as arrows, letters, numbers or other symbols, and applied in locations to be viewable.

Moreover, it is an advantage to provide sheets or films having a layer of phosphorescent material and a layer of reflective material so as to provide directional luminescence of the sheets or films. The reflective layer will reflect the luminescence of the phosphorescent material so that the glow may be brighter and may be sustained longer than typical phosphorescent material.

In addition, it is an advantage of the present invention to provide sheets or films having phosphorescent material contained therein for signage and other applications that further has flame retarded resin or flame retardant additives contained therein. This may be particular useful in situations where signage made from the phosphorescent sheets or films is used for emergency purposes, like during fire or the like. By being flame retardant, the sheets or films will have a lesser ability to produce flames or excess smoke. In addition, the present invention also is laser markable, allowing patterns to be produced in the material as provided by a laser beam or other source of radiation to char or otherwise mark the sheet or film.

Still further, it is an advantage of the present invention to provide a method of making sheets or films having phosphorescent particles contained therein that minimizes the scraping of the insides surfaces of extrusion machinery thereby minimizing the amount of impurities contained within the sheets or films.

And further, it is an advantage of the present invention that thermoplastic pellets may be produced having phosphorescent materials contained therein and further having a lubricating agent that allows the phosphorescent materials to flow through extrusion machinery without scraping the metal sides of the extrusion machinery, thereby avoiding impurities to the phosphorescent materials that may affect the glow characteristics of the phosphorescent materials.

In addition, it is an advantage of the present invention for the phosphorescent sheets or films of the present invention are protected from environmental factors, such as abrasive materials, moisture, oils, and/or acidic or alkaline materials, for example. Moreover, it is an advantage that the phosphorescent sheets or films of the present invention are easily printable with typical printing materials and methods, such as, for example, water or solvent-based inks using flexography, offset lithography, screen printing, UV curable ink printing and ink-jet printing. Moreover, it is an advantage that the phosphorescent sheets or films of the present invention may be easily printable, as described above, without pretreatment of the sheets or films. In addition, it is an advantage that the phosphorescent sheets or films accept a laser-mark.

Moreover, it is an advantage of the present invention that the phosphorescent sheets or films of the present invention are easily adherable to various substrates and materials, with the use of an adhesive backing, so as to be adherable to surfaces such as drywall, plaster, cinder block, concrete, laminate surfaces, painted surfaces, wall paper, wood, plastic moldings, and/or metal, such as aluminum or steel.

Additional features and advantages of the present invention are described in, and will be apparent from, the detailed description of the presently preferred embodiments and from the drawings.

### BRIEF DESCRIPTION OF THE DRAWINGS

FIG. 1 illustrates a cross section of a sheet or film in an embodiment of the present invention having a layer of phosphorescent material and a reflective material.

FIG. 2 illustrates a perspective view of the sheet or film in an embodiment of the present invention.

FIG. 3A illustrates a method of making sheets or films of the present invention in an alternate embodiment of the present invention.

FIG. 3B illustrates an alternate method of making the sheets or films of the present invention.

FIG. 3C illustrates an alternate embodiment of a method of making phosphorescent pellets of the present invention.

FIG. 4 illustrates a perspective view of signage made from the sheets or films in an alternate embodiment of the present invention.

FIG. 5 illustrates a perspective view of a sheet having laser markings thereon in an alternate embodiment of the present invention.

FIG. 6 illustrates a cross sectional view of a sheet having an adhesive layer in an alternate embodiment of the present invention.

FIG. 7 illustrates a cross-sectional view of another sheet having a reflective surface layer in another alternate embodiment of the present invention.

FIG. 8 illustrates a cross-sectional view of an alternate embodiment of a phosphorescent sheet having a protective topcoat layer.

FIG. 9 illustrates a cross-sectional view of a phosphorescent sheet having a protective topcoat layer and an adhesive layer in an embodiment of the present invention.

FIG. 10 illustrates a cross-sectional view of a phosphorescent sheet having a plurality of protective topcoat layers in an alternate embodiment of the present invention.

FIG. 11 illustrates a cross-sectional view of a phosphorescent sheet having a plurality of protective topcoat layers and an adhesive layer in a further alternate embodiment of the present invention.

### DETAILED DESCRIPTION OF THE PRESENTLY PREFERRED EMBODIMENTS

The present invention relates to thermoplastic phosphorescent, rigid or flexible sheets or films, and methods of making the same. More specifically, the present invention relates to multilayer flexible sheets or films having phosphorescent particles incorporated into a layer or layers of the sheets or films. In addition, the sheets or films include a layer of reflective material provided on a backsides of the sheets or films that reflects light emitted from the phosphorescent particles through the front side of the sheets or films. In addition, the sheets or films may include flame retardant resin and/or additives incorporated therein. Still further, the present invention relates to methods of making the flexible thermoplastic phosphorescent sheets or films that minimize impurities from interfering with the luminescent characteristics. In addition, the present invention relates to a method of extruding pellets having phosphorescent materials contained therein.

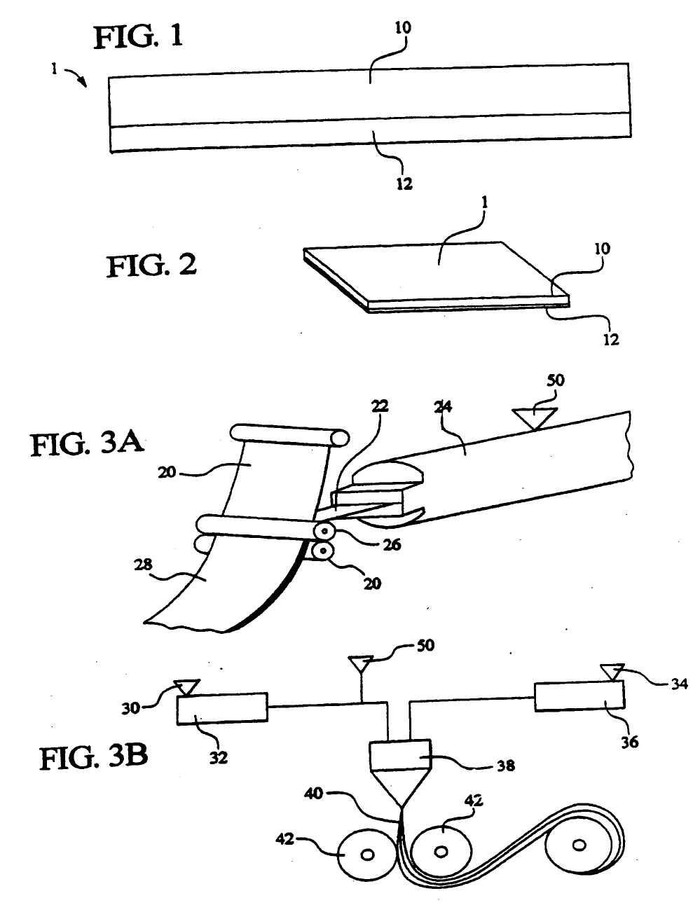

Now referring to the drawings, wherein like numerals refer to like parts, FIG. 1 illustrates a cross-section of a sheet or film 1 in an embodiment of the present invention. The sheet or film 1 may comprise a plurality of layers. Specifically, the sheet or film 1 may comprise a first layer 10 that is adhered to a second layer 12. The first layer 10 may comprise a polymeric material, such as any polymeric material useful for making thermoplastic sheets or films of the present invention. For example, the first layer 10 may preferably be a thermoplastic resin, such as, but not limited to, polyethylene, polypropylene, or blends of these resins. Alternatively, the first layer 10 may comprise a thermoplastic resin, such as, but not limited to, polyethylene, such as metallocene catalyzed linear low density polyethylene (“mLLDPE”), polypropylene (“PP”), polystyrene (“PS”), nylon, polyvinylchloride (“PVC”), polycarbonate, acrylonitrile butadiene styrene copolymer (“ABS”), styrene acrylonitrile (“SAN”), styrene methyl methacrylate (“SMMA”), polytrimethylene terephthalate (“PTT”), polyethylene terephthalate (“PET”), polyethylene terephthalate glycol (“PETG”), polyurethane thermoplastic elastomer (“TPU”), polyester elastomers, acrylic, rigid thermoplastic urethane, styrenic elastomer, ethylene methyl acrylate copolymer (“EMA”), thermoplastic elastomers, or ethylene vinyl acetate copolymer (“EVA”) or blends of any of these resins. Most preferable, the first layer 10 may be made from polyethylene, such as metallocene or single site catalyzed linear low density polyethylene, or polypropylene copolymer or homopolymer, including anhydride modified polypropylene. However, it should be noted that the polymeric material should be transparent or sufficiently translucent to allow electromagnetic radiation, such as visible light and/or other like radiation, to penetrate the first layer 10 and excite the phosphorescent particles contained therein, as noted below.

As noted, the first layer 10 may comprise phosphorescent particles that may provide luminescence when subjected to a source of energy. For example, typical phosphorescent particles may glow when exposed to light, such as visible or ultraviolet light. Of course, any other energy may be utilized to cause luminescence of the phosphorescent particles within the first layer 10, such as electromagnetic radiation. Preferably, the particles that exhibit phosphorescent characteristics, may include, but may not be limited to, strontium aluminate, and/or zinc sulfide (ZnS). With ZnS, an activator, coactivator or compensator is usually necessary, such as copper, aluminum, silver, gold, manganese, gallium, indium, scandium, lead, cerium, terbium, europium, gadolinium, samarium, praseodymium or other rare earth elements and halogens. However, any phosphorescent material may be blended into the polymeric material of the first layer 10 that may cause afterglow luminescence.

As noted above, metal aluminates, such as strontium aluminate, may be utilized as the phosphorescent particles of the present invention. Alternatively, other metal aluminates, such as the alkaline earth aluminate oxides, and/or metal oxides may be used, such as strontium oxide, aluminum oxide, strontium aluminum oxide, calcium aluminum oxide, barium aluminum oxide, silica aluminum oxide, and mixtures thereof. Most preferably, the present invention comprises strontium aluminate particles blended into the matrix of the polymeric thermoplastic material or materials. In addition, the phosphorescent particles utilized in the present invention may be any material apparent to one skilled in the art for providing luminescent characteristics to the thermoplastic material, such as material that will provide afterglow luminescence for minutes, hours, or even days after being exposed to a source of energy, such as electromagnetic radiation.

The first layer 10 may comprise between about 5 percent by weight and 70 percent by weight phosphorescent particles. Preferably, the first layer 10 may comprise about 30 percent by weight and 50 percent by weight of the phosphorescent particles. Of course, the loading of the phosphorescent particles within the polymeric thermoplastic resins is dependent on the thermoplastic material itself. For example, polyethylene, which is relatively soft and easily flows when melted, may be loaded with a relatively high amount of phosphorescent material, such as about 50 to about 70 percent by weight. Alternatively, a relatively hard or stiff thermoplastic material such as PET, having relatively less flowability when melted, may be loaded with less of the phosphorescent material, such as about 5 to about 30 percent by weight of the total composition. Of course, the phosphorescent material is relatively expensive, so the amount used should be as low as possible but sufficient to attain the desired degree of glow from the pellets and shaped articles made therefrom.

The second layer 12 of the sheet or film 1 may comprise a polymeric material that is useful to operate as a reflective backing to the first layer 10. The second layer 12 may preferably comprise the same material as used in the first layer 10. However, this is not necessary, and it should be noted that any polymeric material may be utilized as the second layer 12 that may adhere compatibly with the first layer 10. For example, the second layer 12 may comprise polyethylene, such as mLLDPE, PP, PS, nylon, PVC, polycarbonate, ABS, SAN, SMMA, PTT, PET, PETG, TPU, polyester elastomers, acrylic, rigid thermoplastic polyurethane, styrenic elastomers, EMA, EVA, thermoplastic elastomers or blends of any of these resins. Preferably, however, the polymeric material of second layer 12 may be a polyolefin, such as low density polyethylene, or anhydride modified polypropylene.

The second layer 12 of the sheet or film 1 may further comprise a pigment that operates to reflect light away from the second layer 12. Preferably, the pigment is white, but other pigments may be utilized that provide similar reflective properties. For example, off-white, or other non-white colors may be utilized that reflects light from the second layer 12. A preferable pigment that may be blended with the polymeric material of the second layer 12 is titanium dioxide. However, any other pigmenting compound apparent to one having ordinary skill in the art of pigmenting polymers may be utilized. Typically, the amount of titanium dioxide blended into the second layer 12 may be relatively low, such as between about 1 percent by weight and 3 percent by weight. However, depending on the pigmenting ability of the pigments, other concentrations may be utilized. For example, and as noted below, flame retarded resins and/or flame retardant additives may be added to the second layer 12 at a concentrations of between about 99 percent by weight and about 1 percent by weight. Most preferably, if a flame retarded resin or a flame retardant additive is utilized as the pigmenting compound, the polymeric material of the second layer 12 may have about 30 percent by weight pigmenting flame retarded resin or flame retardant additive.

The second layer 12 may be adhered to the first layer 10 in any way apparent to one having ordinary skill in the art of making multiple layer films or sheets. For example, the first layer 10 and the second layer 12 may be individually extruded through an extrusion die, such as a cast extrusion die or a blown film extrusion die. The layers may then be adhered together using an adhesive, or may be extrusion laminated together.

Preferably, the sheets or films of the present invention are extruded, as opposed to cast liquid resin systems. Because the phosphorescent pigments contain both large and small crystals, cast liquid resin systems tend to allow the bigger particles to settle or sink to the bottom of a casted sheet. The bigger particles tend to glow brighter and longer than smaller particles. If the bigger particles sink or settle, the smaller particles will block the bigger particles from exposure thereby decreasing the activation of the bigger particles. In an extruded process, the particles are evenly distributed throughout the layer 10, thereby allowing a larger amount of the bigger particles to be activated.

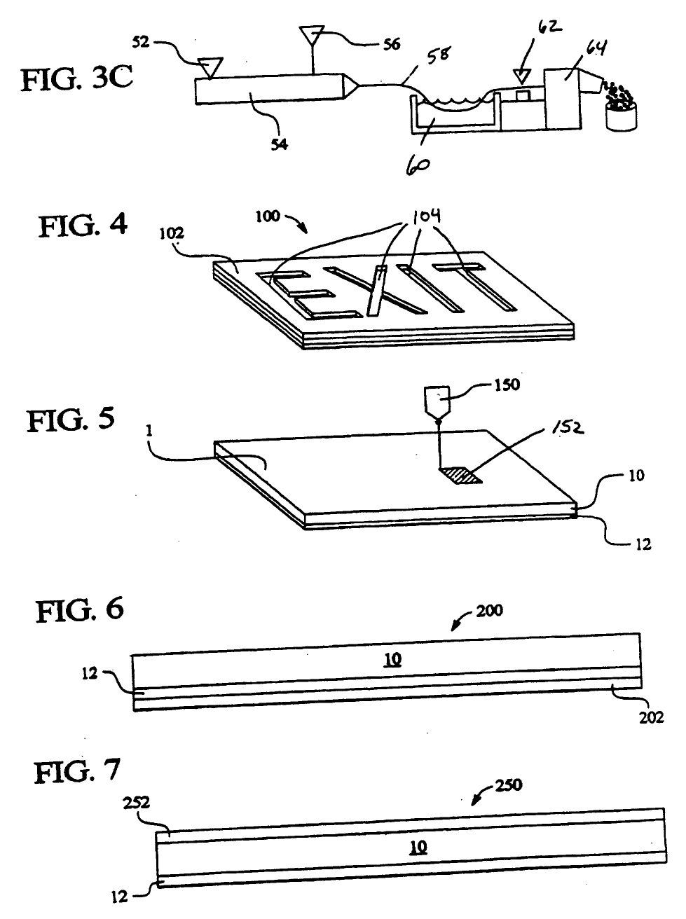

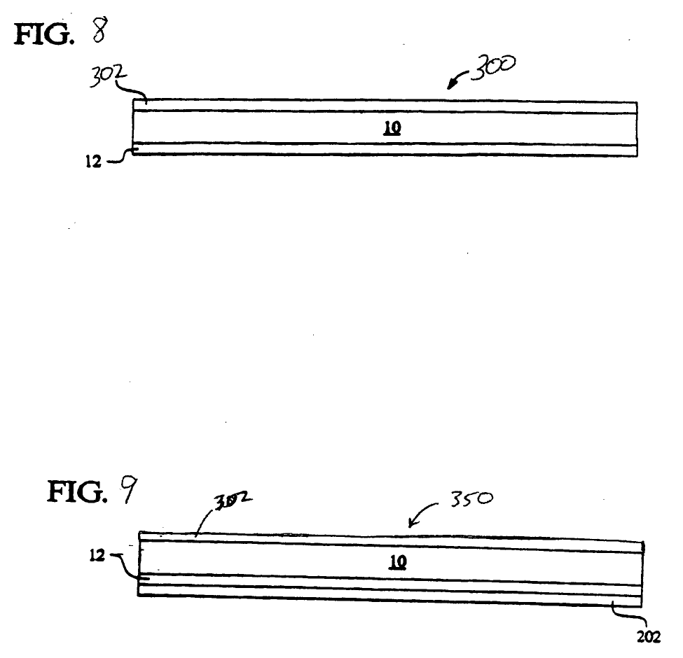

For example, as shown in FIG. 3A, the first layer 10 may be extruded first and formed into a sheet or film 20. The second layer 12 may then be extruded into a sheet or film 22 via an extruder 24, and while still in melt form may be extruded onto the first layer 10. The first layer 10 and the second layer 12 may then be passed through nip rollers 26 to adhere the second layer 12 to the first layer 10 to form a two-layer sheet or film 28.

Alternatively, as shown in FIG. 3B, the first layer and the second layer may be coextruded together to form a two layer coextruded melt stream that may be extruded to form a two layer sheet or film. The polymeric material of the first layer 10 may be added in pellet form to hopper 30 and melted via a melt screw 32. The polymeric material of the second layer 12 may be added to a hopper 34 and melted via a melt screw 36. The two melt streams may then be combined in an extrusion die 38 and extruded to form a two-layer sheet or film 40 that may be cooled via chilled nip rollers 42. Of course, other methods of bonding the layers of the sheets or films together may be utilized, such as adhesion with the use of adhesive and/or solvents, and ultrasonic or laser weld bonding.

As illustrated in FIGS. 3A and 3B, the phosphorescent particles are added to the polymeric material after the polymeric material has been melted to minimize wear of the extrusion equipment. The phosphorescent particles, such as the strontium aluminate crystals, may be added to the polymeric material at a location 50 downstream from where the polymeric material melts. Alternatively, the phosphorescent particles may be encapsulated to allow the phosphorescent particles to be blended without abrasion. Specifically, if the phosphorescent particles were added to the solid polymeric material prior to melting, then the phosphorescent particles would seriously abrade the inside metal surfaces of the melt screw that is used to melt the polymeric material. Not only would this damage and wear the inside metal surfaces of the melt screw and other extrusion equipment, many metal particles would be added to the polymeric thermoplastic material thereby interfering with the luminescence of the phosphorescent particles.

The polymeric material that is blended with the phosphorescent material may further comprise a lubricating material that adheres to the metal surfaces of the extrusion equipment and die head. This allows the phosphorescent particles to pass through the extrusion equipment without scraping or abrading the metal surfaces of the extrusion equipment. The amount of metal that is scraped from the walls of the extrusion equipment is, consequently, reduced, thereby minimizing the amount of metal particles that may interfere with the luminescence of the phosphorescent material. Although any lubricating material may be utilized in the present invention that blends with the polymeric material and adhere to the metal surface of the extrusion equipment thereby allowing the polymeric melt to pass therethrough without scraping metal particles from the extrusion equipment, a particularly preferred lubricating material is perfluoropolymer synthetic oil, also known as FLUOROGUARD® from DuPont. Other notable lubricants that may be used may be zinc sterate, long chain paraffin wax, mineral oil, polyolefin waxes, and/or boron nitride or various fluoropolymers such as tetrafluoroethylene (“TFE”), also known in the trade as Teflon®, polyvinylidene fluoride-hexafluoropropylene copolymer, and/or perfluoropolyethylene (“PFPE”). Of course, other known lubricants that adhere to the metal surfaces of the extrusion equipment and die head may be utilized.

The lubricating material may be present within the polymeric material that is combined with the phosphorescent material at a concentration of between about 0.01 percent by weight and 10 percent by weight. Most preferably, the lubricating material may be present within the polymeric material of layer 10 at a concentration of about 0.4 percent by weight. Typically, the lubricating material is added to the polymeric. thermoplastic resin while the polymeric thermoplastic resin is in pellet form prior to adding the polymeric thermoplastic resin is added to the melt extruder. The lubricating material may be added to a mixer with the polymeric thermoplastic material and therefore thoroughly blended with the polymeric thermoplastic resin.

After the polymeric material has been blended with the phosphorescent material and/or the lubricating material, the polymeric material may be extruded into pellets, as illustrated in FIG. 3C so that the blended polymeric material may be stored, transported and/or otherwise utilized at a time in the future. The pelletizing of the blend of polymeric material, phosphorescent material, and/or lubricating material may be accomplished in any manner as may be apparent to one having ordinary skill in the art. Thermoplastic material is simply added to a hopper 52 that feeds the pellets into a melt screw 54 that melts the polymeric material under increased temperature and pressure. The lubricating material is typically added to the thermoplastic material prior to adding the thermoplastic material to the hopper 52. In addition, the phosphorescent material may be added to the polymeric material at a location 56 downstream from where the polymeric material melts to minimize wear of metal surfaces within the extruder by the phosphorescent material. Moreover, the phosphorescent material may be added to the melt screw 54 within a “decompression zone” of the melt screw, where pressure is decreased within the melt screw to minimize the agitation of the melted thermoplastic material. When phosphorescent material is added to the decompression zone, wear is minimized due to the decrease in agitation.

Typically, strands or filaments 58 are extruded from the melt screw 54 and cooled within a water bath 60. An air knife 62 is typically used to dry the strand or filament 58. The strand or filament 58 is then added to a pelletizer 64 and formed into pellets by blades contained within the pelletizer 64. The strand or filament 58 can also be cut into pellets by means of an underwater pelletizer. The pellets are then collected, stored, or utilized to form articles by melting the pellets and extruding the same as described above.

The pellets are made from the same list of thermoplastic resins as included above, including polyethylene, such as mLLDPE, PP, PS, nylon, PVC, polycarbonate, ABS, SAN, SMMA, PTT, PET, PETG, TPU, polyester elastomers, acrylic, rigid thermoplastic polyurethane, styrenic elastomers, EMA, EVA, thermoplastic elastomers or blends of any of these resins. The pellets are formed into articles via a number of different processes, including, but not limited to: injection molding, compression molding, gas assist injection molding, profile extrusion, sheet extrusion (including co-extrusion), extrusion blow molding, injection blow molding, film extrusion, cast extrusion, blown film extrusion, rotational molding, and extruded denier.

The pellets, as described herein, may be molded into a plurality of different glow-in-the-dark articles, such as automotive trunk latch releases, boat cleats, helmets, flashlight housings, cell phone cases, medical devices, textile industry (spider webbing, and denier (thread) to make garments). Preferably, according to the present invention, the pellets may be formed into sheets or films 1, as described above. Of course, any other article may be made with the glow-in-the-dark pellets as may be apparent to one having ordinary skill in the art.

As illustrated in FIG. 2, the sheet or film 1 of the present invention may therefore have the first polymeric layer 10 having the phosphorescent particles contained therein and, optionally, the lubricating material, and the second polymeric layer 12 may comprise the pigment contained therein. After exposure to radiation, such as visible light or ultraviolet radiation, the phosphorescent material in the first layer 10 may glow for a period of time after exposure to the radiation, known as the afterglow for a period of minutes, hours or even days. The second layer 12 may operate to reflect any luminescence back through the first layer. Therefore, little luminescence escapes through or is absorbed in the second layer 12 of the sheet or film 1 due to its reflective characteristics. All luminescence emanating from the sheet or film 1 is directed to escape from the sheet or film 1 through the first layer 10 of the sheet or film 1.

By providing the reflective second layer 12 adhered to the phosphorescent first layer 10, the glow emanating directionally through and from the first layer 10 has more luminescence than without the reflective second layer 12. The sheet or film 1, therefore, of the present invention is brighter and the glow lasts longer than sheets or films without the reflective second layer 12 adhered to the first layer 10. The following chart shows a typical difference in luminescence between a sheet or film (sheet A) without the reflective layer adhered to the phosphorescent layer, and a sheet or film (sheet B) having the reflective layer adhered to the phosphorescent layer:

TABLE 1

| Time | Sheet A afterglow luminance | Sheet B afterglow luminance |
|---|---|---|
| (minutes) | (mcd/m²) | (mcd/m²) |
| 1 | 160.2 | 333.0 |
| 5 | 35.7 | 73.5 |
| 10 | 17.9 | 36.5 |
| 15 | 11.5 | 23.7 |
| 20 | 8.5 | 17.5 |
| 25 | 6.6 | 13.6 |
| 30 | 5.4 | 11.0 |
| 35 | 4.5 | 9.2 |
| 40 | 3.9 | 7.9 |
| 50 | 3.0 | 6.1 |
| 60 | 2.5 | 5.0 |
| 90 | 1.4 | 2.9 |
| 120 | 1.0 | 2.0 |

As can be seen by the results in Table 1, the luminance of sheet B (having the reflective layer adhered thereto) had about twice the luminance as sheet A (without the reflective layer). Although not shown by Table 1, above, the time for the luminance to decrease to about 0.3 mcd/m² was about 307 minutes for sheet A and 513 minutes for sheet B.

Additionally, the sheet or film 1, as described with reference to FIG. 1, may further contain flame retarded resin and/or flame retardant additives. Therefore, the flame retarded resin and/or additives may be added to the layer 12 of the sheet or film 1. In fact, typical flame retarded resins and/or flame retardant additives are mostly white or whitish in color. Therefore, the flame retardant resin and/or additives may be utilized to provide the layer 12 with its reflective characteristics as well as its flame retardant characteristics. Of course, a combination of flame retarded resin and/or flame retardant additive and pigment, such as titanium dioxide, may be utilized to give the layer 12 its reflective characteristics.

Notable flame retardant additives or resins may comprise the following: ethane-1,2 bis(pentabromophenyl), tris (tribromophenyl) triazine, tris (tribromoneopentyl) phosphate, tetrabromobisphenyl A-bis(2,3-dibromopropyl ether), bis (3,5-dibromo-4-dibromopropyloxy phenyl) sulfone, brominated polystyrene, pentabromobenzyl acrylate, poly (pentabromobenzyl acrylate), hexabromocyclododecane, decabromodiphenyl oxide, tetrabromobisphenol-A, brominated trimethylphenyl indan, brominated epoxy oligomers, magnesium hydroxide, aluminum hydroxide, alpha-alumina monohydrates, melamine cyanurated, melamine phosphate, melamine pyrophosphate, melamine polyphosphate, metallic salts of phosphinate, triphenyl phosphate, resorcinol diphosphate, bisphenol-A diphosphate, dimer of bisphenol-A diphosphate, aromatic polyphosphate, aromatic oligophosphate, tetradecabromodiphenoxy benzene, ethylene bis-dibromocyclohexane, dibromostyrene, poly dibromostyrene, phenoxy-terminated carbonate oligomer of tetrabromobisphenol-A, poly (dibromophenylene oxide), bis (tribromophenoxy) ethane, antimony trioxide, antimony pentoxide, sodium antimonate, zinc borate, calcium borate, pentaerythritol, zinc molybdate, magnesium silicate, zinc phosphate, zinc oxide, zinc stannate, zinc hydroxystannate, calcium zinc molybdate, molybdic oxide, N-butylbenzene sulfonamide, melamine salt of ethylene diamine phosphate, ammonium polyphosphate, organically-bound nitrogen/ammonium polyphosphate synergistic mixtures, polytetrafluoroethylene, potassium perfluorobutane sulfate, and potassium sulfonate salt. Of course, any other flame retarded resin and/or flame retardant additive may be utilized as may be apparent to one having ordinary skill in the art. A preferable flame retarded resin and/or flame retardant additive is decabromodiphenyl oxide.

The flame retardant resin additive may be present in a concentration of between about 0.5 weight percent and about 70 weight percent. More preferably, the flame retarded resin and/or flame retardant additive may be present in the layer 12 in a concentration of between about 10 weight percent and about 50 weight percent. Most preferably, the flame retardant additive may be present in a concentration of about 30 weight percent.

As with the polymeric material utilized in layer 10, the polymeric material utilized in layer 12 may be converted into pellet form after being melted and combined with the flame retardant additive, as noted above, to be stored, transported, or otherwise utilized in the future to make the sheet or film 1 of the present invention. Of course, the pelletizing of the polymeric material blended with the flame retarded resin and/or flame retardant additive may be accomplished in any manner apparent to one having ordinary skill in the art. When used, the pellets are simply added to a hopper that feeds the pellets to a melt screw that melts the polymeric material blended with the flame retarded resin and/or flame retardant additive under increase temperature and pressure.

The sheet or film 1 of the present invention may be converted into signage, as illustrated in FIG. 4. FIG. 4 shows an exit sign 100 that may be constructed from the sheet or film material. The sheet or film 1 may have a template 102 with the word “EXIT”, or any other word cut out of the template 102, placed over the sheet or film 1 thereby blocking transmission of the luminescence of the phosphorescent material. Only an area 104 exposed by the template 102 may show luminescence through the template 102. Of course, the sheet or film 1 may be covered by any material that may be utilized to block transmission of luminescence from the sheet or film 1, such as ink, so that specific letters, words, symbols or the like may be transmitted to a viewer. The exit sign 100 may be placed over a door, for example, and may absorb radiation, such as visible light or ultraviolet radiation. If a visible light source is extinguished, then the luminescence of the exit sign 100 will be visible to a viewer, and a viewer will know where to locate the exit. Alternatively, the sheet or film 1 may be cut into strips and laid down on a floor to indicate a particular path to travel if a visible light source is extinguished. The strips are particularly useful on either sides of aisles, such as aisles of an airplane or the like. However, the sheet or film 1 may be cut or slit into any shape to be used to provide luminescence.

FIG. 5 illustrates a further embodiment of the present invention. Specifically, the sheet or film 1 may be marked via a laser 150 or other source of radiation to provide markings 152 on the sheet or film 1 that may be visible to viewers of the sheet or film 1. As indicated above, the layer 10, comprising the phosphorescent material, may be transparent or translucent so that a laser beam will be transmitted through the polymeric material and will not char or otherwise mark the polymeric material as necessary to provide the markings 152. However, the layer 12 may be utilized to absorb laser radiation and, consequently, be charred by the laser radiation. Any type of laser beam may be utilized that is useful to char the layer 12 of the sheet or film 1 to provide the markings 152.

FIG. 6 illustrates a cross-sectional view of a sheet or film 200 having the layer 10 comprising the phosphorescent particles and optionally, the lubricating material and/or the flame retardant resin and/or additives. Further, the sheet or film 200 may have the layer 12 comprising the reflective material, such as the white or whitish pigment and/or the flame retardant resin and/or additives.

In addition, the sheet or film 200 may further comprise an adhesive layer 202 that is provided on a surface of the sheet or film 200 for adhering the sheet or film 200 or signage made from the sheet or film 200 to surfaces. Preferably, the adhesive layer 202 may be provided on a surface of the reflective layer 12 for adhering the signage to surfaces so that the layer 10 having the phosphorescent particles is viewable. The adhesive layer 202 may not be disposed over the entire surface of the sheet or film 200, but may be applied in particular areas as necessary to adhere the sheet or film 200 to a surface. Alternatively, the adhesive layer may be located on the surface of the layer 10 for adhering the sheet or film to surfaces through which the layer 10 may be viewable, such as through glass or transparent plastic.

The adhesive layer 202 may be a permanent or removable adhesive. A backing layer (not shown) may be utilized to protect the adhesive layer 202, and may be removable from the adhesive layer 202 when the sheet or film 200 is to be adhered to a surface. Specifically, the sheet or film 200 may be preferably adhered to a clean and dry surface, such as drywall, plaster, cinderblock, concrete, laminate surfaces, painted surfaces, wall paper, wood, plastic moldings, and/or metal, such as aluminum or steel. Common adhesives that may be utilized in the present invention include acrylic adhesives, cellulose or gums, epoxies, glues, polyurethanes (PUR) and urethanes, rubber and silicone, for example. Moreover, adhesives may include thermoset materials, thermoplastic materials, water activated, and pressure sensitive.

FIG. 7 illustrates an alternate embodiment of the present invention in a cross-sectional view of a sheet or film 250. The sheet or film 250 may include the layers 10,12 as described above, and may further comprise a layer 252 disposed on a surface of the layer 10 for reflecting light that may be directly applied to the sheet or film 250 or signage made from the sheet or film 250. The reflective layer 252 may be a clear, or mostly clear thermoplastic resin having a reflective material added thereinto. The reflective material may be, for example, any silicone-based material having reflective properties, such as HELICONE® HC Maple, HELICONE® HC Scarabeus, HELICONE® HC Jade and HELICONE® HC Sapphire, from Wacker Silicones Corporation. In addition, various micas, such as titanate-coated micas may be utilized as well for their reflective properties.

Any clear or mostly clear polymeric resin may be utilized and blended with the reflective material to form the reflective layer 252. As with the other layers 10, 12, reflective layer 252 may be extruded and laminated to the other layers 10, 12. A preferable polymeric resin utilized for the reflective layer 252 is mLLDPE.

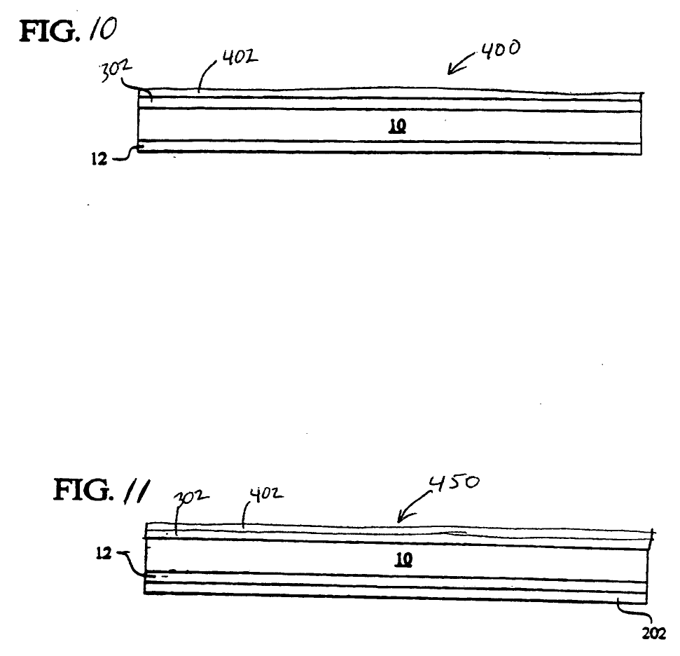

FIG. 8 illustrates a still further alternate embodiment of the present invention of a sheet or film 300 having layers 10, 12 as described above, and a topcoat layer 302 disposed on a surface of the first layer 10, which comprises the phosphorescent material. The topcoat layer 302 may be disposed on and adhered to the first layer 10 to provide protection to the first layer 10, and any other layers present in the sheet or film 300. Specifically, the topcoat layer 302 may be utilized to protect the sheet or film 300 from abrasive materials that may cause scratches or scuffing of the first layer 10. In addition, the topcoat layer 302 may further protect the sheet or film 300 from environmental factors, such as exposure to moisture, oils, and/or acidic or alkaline materials, for example. Preferably, the topcoat layer 302 may be between about 1 mils and about 10 mils thick. Most preferably, the topcoat layer 302 may be about 1.3 mils thick.

The topcoat layer 302 may be transparent or substantially transparent to allow light to penetrate the first layer 10 to excite the phosphorescent material disposed therein and to all the glow characteristics of the first layer 10 to be viewable. The topcoat layer may be any material useful for this purpose, such as, for example, thermoplastic resins such as acrylic, polyethylene terephthalate (PET), polyethylene terephthalate glycol (PETG), polyamide, polycarbonate, polypropylene, polyethylene, polyurethane, polystyrene, or oriented polyester.

The topcoat 302 may further be easily printed with ink. Specifically, water-based or solvent-based inks may be utilized to print patterns or information on the sheet or film 300. Typical printing methods that may be utilized are flexography, offset lithography, screen printing, UV curable ink printing, and ink jet printing. Further, the topcoat 302 may be laser markable as well. The topcoat 302 may further prevent out-gassing that may occur with other polymeric materials.

FIG. 9 illustrates a still further embodiment of a sheet or film 350 having the layers 10, 12 as described above, and further having the topcoat layer 302, as described above with respect to FIG. 8. Further, the sheet or film 350 may have the adhesive layer 202, as described above with respect to FIG. 6 disposed on a surface of the second layer 12 for adhering the sheet or film 350 to a surface. A backing layer (not shown) may be utilized over the adhesive layer 202 to protect the adhesive layer 202 and prevent accidental adhesion of the sheet or film 350. The adhesive layer 202 allows the sheet or film 350 to adhere to surfaces, such as drywall, plaster, cinderblock, concrete, laminate surfaces, painted surfaces, wall paper, wood, plastic moldings, and metal, such as aluminum or steel, for example.

FIG. 10 illustrates a still further alternate embodiment of the present invention of a sheet or film 400 having the layers 10, 12 as described above with respect to FIG. 1, and a topcoat layer 302, as described above with respect to FIG. 8. In addition, a further coating 402 may be provided on the topcoat layer 302 for providing further protection of the sheet or film 400. The coating 402 may be any material useful. Specifically, the coating 402 may be acrylic-coated PET. Of course, any number of layers may be provided comprising material for protecting the sheet or films described herein.

FIG. 11 illustrates a still further embodiment of a sheet or film 450 having the layers 10, 12, as described above with respect to FIG. 1, as well as the adhesive layer 202, the topcoat layer 302, and the coating 402. The sheet or film 450 allows a sheet or film, or tape if the sheet or film is cut down, to be adhered to surfaces, while having the protection of the topcoat 302 and coating 402.

### EXAMPLE 1

A multilayer sheet was prepared in accordance with the present invention. Specifically, a two-layer sheet was co-extruded having a first layer and a second layer, wherein the first layer comprised the phosphorescent material and the second layer comprised a reflective material for reflecting the luminescence of the first layer. The first layer comprised about 50 percent by weight clarified mLLDPE, and about 50 percent by weight of quick-activating strontium aluminate crystals.

Specifically, about 50 b mLLDPE was mixed in a mixer with 0.22 b (0.4 percent by weight) lubricant. The mLLDPE and lubricant mixture was then added to a first melt screw. After the first melt screw had melted the mLLDPE and lubricant mixture, about 50 b strontium aluminate crystals were added to the mixture at a location downstream (i.e. the decompression zone of the melt screw) to minimize the wear on the inside of the melt screw from the strontium aluminate crystals.

At the same time, mLLDPE pellets were mixed with titanium dioxide to form a mLLDPE/flame retardant mixture having 70 percent by weight mLLDPE and 30 percent by weight brominated polystyrene, a flame retardant additive. The mLLDPE/flame retardant mixture was mixed together prior to adding the mLLDPE/flame retardant mixture to a second melt screw. The mLLDPE/flame retardant mixture was melted in the second melt screw, and combined with the first melt stream to form a two-component extrudate. The extrudate was then cast extruded and cooled to form a sheet having two layers, wherein a first layer comprised the phosphorescent material, and the second layer comprises the reflective material.

### EXAMPLE 2

A second multilayer sheet was produced according to the present invention. The second multilayer sheet was made similarly to the multilayer sheet as described with reference to Example 1, except that the first layer comprised about 55 percent by weight mLLDPE, about 45 percent by weight regular-activating strontium aluminate particles, and about 0.4 percent by weight lubricant.

### EXAMPLE 3

The multilayer sheet of Example 1 was laminated with a PET film covering the surface of the phosphorescent layer, and further included a thin acrylic layer covering the PET film. The topcoat of PET measured about 1.3 mils thick. The layer of acrylic measured about 0.3 mils thick.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

1. A sheet or film having a first side and a second side comprising:
a first layer comprising a first polymeric material and a phosphorescent material; and
a second layer adhered to said first layer comprising a second polymeric material wherein said second polymeric material reflects the luminescence of the phosphorescent material of the first layer; and
a substantially transparent third layer disposed on the first layer.

2. The sheet or film of claim 1 wherein the first polymeric material comprises a polymeric resin selected from the group consisting of polyethylene, metallocene-catalyzed linear low density polyethylene, polypropylene, polystyrene, nylon, polyvinylchloride, polycarbonate, acrylonitrile butadiene styrene copolymer, styrene acrylonitrile, styrene methyl methacrylate, polytrimethylene terephthalate, polyethylene terephthalate, polyethylene terephthalate glycol, polyurethane thermoplastic elastomer, polyester elastomers, acrylic, rigid thermoplastic urethane, styrenic elastomer, ethylene methyl acrylate copolymer, ethylene vinyl acetate copolymer, thermoplastic elastomers, and blends of these materials.

3. The sheet or film of claim 1 wherein the substantially transparent third layer comprises a thermoplastic material.

4. The sheet or film of claim 3 wherein the thermoplastic material is selected from the group consisting of metallocene catalyzed polyethylene, acrylic, polyethylene therephthalate, polyethylene terephthalate glycol, polyamide, polycarbonate, polypropylene, polyethylene, polyurethane, polystyrene, oriented polyester, or blends of these materials.

5. The sheet or film of claim 1 further comprising:
a fourth layer disposed on the third layer.

6. The sheet or film of claim 5 wherein the fourth layer comprises acrylic.

7. The sheet or film of claim 5 wherein the third layer comprises polyethylene terephthalate and the fourth layer comprises acrylic.

8. The sheet or film of claim 1 wherein the phosphorescent material comprises particles selected from the group consisting of zinc sulfide, metal aluminate, and metal oxides.

9. The sheet or film of claim 1 wherein the second polymeric material is selected from the group consisting of polyethylene, metallocene-catalyzed linear low density polyethylene, polypropylene, polystyrene, nylon, polycarbonate, acrylonitrile butadiene styrene copolymer, styrene acrylonitrile, styrene methyl methacrylate, polytrimethylene terephthalate, polyethylene terephthalate, polyethylene terephthalate glycol, polyurethane thermoplastic elastomer, polyester elastomers, acrylic, rigid thermoplastic urethane, styrenic elastomer, ethylene methyl acrylate copolymer, ethylene vinyl acetate copolymer, and thermoplastic elastomers.

10. The sheet or film of claim 1 wherein said second layer further comprises a reflective material.

11. The sheet or film of claim 5 wherein the reflective material is selected from the group consisting of titanium dioxide and a flame-retardant additive.

12. The sheet or film of claim 1 further comprising a flame retardant additive in one of the layers.

13. The sheet or film of claim 12 wherein the flame retardant additive is selected from the group consisting of: ethane-1,2 bis(pentabromophenyl), tris(tribromophenyl) triazine, tris (tribromoneopentyl) phosphate, tetrabromobisphenyl A-bis(2,3-dibromopropyl ether), bis (3,5-dibromo-4-dibromopropyloxy phenyl) sulfone, brominated polystyrene, pentabromobenzyl acrylate, poly (pentabromobenzyl acrylate), octabromodiphenyl oxide, decabromodiphenyl oxide, tetrabromobisphenol-A, brominated epoxy oligomers, brominated epoxy polymers, magnesium hydroxide, aluminum hydroxide, alpha-alumina monohydrates, melamine cyanurated, melamine phosphate, melamine pyrophosphate, melamine polyphosphate, metallic salts of phosphinate, triphenyl phosphate, resorcinol diphosphate, bisphenol-A diphosphate, dimer of bisphenol-A diphosphate, aromatic polyphosphate, aromatic oligophosphate, tetradecabromodiphenoxy benzene, ethylene bis-dibromocyclohexane, dibromostyrene, poly dibromostyrene, phenoxy-terminated carbonate oligomer of tetrabromobisphenol-A, poly (dibromophenylene oxide), bis (tribromophenoxy) ethane, antimony trioxide, antimony pentoxide, sodium antimonate, zinc borate, calcium borate, pentaerythritol, zinc molybdate, magnesium silicate, zinc phosphate, zinc oxide, zinc stannate, zinc hydroxystannate, calcium zinc molybdate, molybdic oxide, N-butylbenzene sulfonamide, melamine salt of ethylene diamine phosphate, ammonium polyphosphate, organically-bound nitrogen/ammonium polyphosphate synergistic mixtures, polytetrafluoroethylene, potassium perfluorobutane sulfate, potassium sulfonate salt and mixtures thereof.

14. The sheet or film of claim 1 further comprising:
a fourth layer disposed on said sheet or film wherein said fourth layer comprises an adhesive material.

15. The sheet or film of claim 1 wherein said first layer further comprises a lubricant material blended into said first polymeric material of the first layer.

16. The sheet or film of claim 1 further comprising:
a fourth layer disposed on the third layer.

17. The sheet or film of claim 16 wherein the fourth layer comprises acrylic-coated polyester.

18. The sheet or film of claim 16 further comprising:
a fifth layer comprising an adhesive material disposed on the second layer for adhering the sheet or film to a surface.

19. The sheet or film of claim 1 further comprising:
ink printed on the third layer of the sheet or film.

20. A sign made from the sheet or film of claim 1.
